(19) United States
(12) Patent Application Publication
(10) Pub. No.: US 2009/0092828 A1
(43) Pub. Date: Apr. 9, 2009

(54) MULTI-LAYER SUPPORT

(75) Inventor: Maarten Constant Gerlach Marie MEIJLINK, Kaatsheuvel (NL)

Correspondence Address: BANNER & WITCOFF, LTD., 28 STATE STREET, 28th FLOOR, BOSTON, MA, 02109-9601, US

(73) Assignee: FUJIFILM Manufacturing Europe B.V., Tilburg (NL)

(21) Appl. No.: 12/250,985

(22) Filed: Oct. 14, 2008

Related U.S. Application Data
(63) Continuation of application No. PCT/NL2007/050170, filed on Apr. 20, 2007.

(30) Foreign Application Priority Data
Apr. 20, 2006 (EP) 06075923.0

(51) Int. Cl. B32B 27/32; B32B 27/30; B29C 63/00

(52) U.S. Cl. 428/342; 428/522; 428/523; 428/341; 264/173.1

(57) ABSTRACT

The present invention relates to a support for a recording medium comprising a substrate having a topside and a backside on which the topside is provided with at least two resin layers, the layer furthest away from said support which is most distant from the substrate comprises a copolymer of an α-olefin and an α,β-unsaturated carboxylic acid, an α-olefin and an ester of an α,β-unsaturated acid, an α-olefin and an anhydride of an α,β-unsaturated di-carboxylic acid or an α-olefin and an vinyl-ester.

### RELATED APPLICATIONS

This application is a continuation of PCT application no. PCT/NL2007/050170, designating the United States and filed Apr. 20, 2007; which claims the benefit of the filing date of European application no. 06075923.0, filed Apr. 20, 2006; each of which is hereby incorporated herein by reference in its entirety for all purposes.

### FIELD

The present invention relates to a support material, in particular a resin coated support material for use in recording applications. The invention further relates to a recording medium comprising such a support material.

### BACKGROUND

In general a support material used in recording media comprises a substrate on which at least one resin layer is supplied. On top of this resin layer a receiving medium is applied depending on the recording method used, e.g. an emulsion layer for (conventional) photography applications or an ink receiving layer for inkjet applications.

Typically, recording media for imaging methods, and in particular recording media for photographic paper, are produced by using a melt-extrusion coating method or co-extrusion method. In (co-)extrusion coating, molten polymer layer(s) is (are) typically extruded through a slot die at elevated temperatures exceeding 270° C. While in molten state, the polymer layer(s) is (are) drawn through the nip of two rollers together with the substrate to be coated. One of these rollers, the chill roller, is cooled in order to solidify the polymer layer(s). The other roller, the nip roller, which is usually provided with a layer of a compressible material on its circumference, applies pressure to effect the adhesion of the substrate and the polymer layer(s).

An important aspect of the support is the resin surface appearance, which should be smooth and exhibiting a high gloss. Further it is important that the resin surface of the support does not have too many crater defects, also named pits, which may be caused by air entrapment by the rotation of the chill roll, upon melt-extrusion coating of resin on the substrate. When the number of pits increases, the outer appearance of the support is damaged and the quality of the recording media prepared using such a support deteriorates.

The number of pits increases when using higher line-speeds in extrusion coating and therefore it has been difficult to increase the production speed and productivity in the manufacturing of supports for recording media.

The number of pits also increases with a reduction of the total thickness of the resin layers of the support. Therefore, it has been difficult to reduce the costs of the supports for recording media. The number of crater defects of a resin coated substrate can be reduced by increasing the melt temperature of the resin layers above the temperature that would be needed to assure the adhesion of the resin layer(s) with the substrate. This is generally not preferred because of its associated risks for generating more defects, for instance because it may give rise to die drool. These defects lead to a deterioration of the appearance of the support and require a production stop to remedy them.

In the prior art various solutions for above mentioned crater defect problems are proposed.

EP-A-0 285 146 describes a method of reducing the number of crater defects at high extrusion line speeds such as 200 m/min, by replacing the air on the chill roller with a gas which can escape more readily through the extruded resin film.

JP-A-11 352 638 describes another method at high extrusion line speeds such as 200 m/min in which a resin film coming out of an extruder is passed between a nip and a cooling roller along with the base material and where the temperature of the resin film in the nip is increased.

EP-A-1 130 460 describes another method at high extrusion line speeds such as 300 m/min in which a paper substrate is heated prior to extrusion coating with polymer resin layer(s). Also other publications propose methods for the reduction of craters with a major disadvantage in the technical complexity or potential risk for damage to production equipment of the proposed system or increased number of production steps in producing the support.

For example, in JP-A-11 352 637 a process is described in which after the first nip, new pressing with hot roller(s) is used at least one time. In U.S. Pat. No. 4,994,357 a process is described in which upon extrusion coating the molten resin layer(s) are passed between a chill roller and a back-up roller under a linear pressure up to 200 kg/cm. In JP-A-59 198 451 a process is described in which the support is prepared by double consecutive extrusion coating.

In the art of providing support materials for recording media there remains a need for low costs and high speed production of the media, whereby the amount of crater defects on the support remains at a sufficiently low level.

### SUMMARY

It is an object of the present invention to provide a support for recording media with good surface properties, i.e. a low amount of crater defects.

It is a further object of the present invention to provide a support for recording media that can be produced at very high line speed during melt extrusion-coating, without sacrifice to the surface properties.

It is a further object of the present invention to provide a support for recording media having a low thickness of polymer resin, expressed as weight of resin per surface area, which can be produced at high extrusion speed, whereby good surface properties are maintained.

It is another object of the present invention to provide a support for recording media at relatively low resin melt temperature with superior surface properties, i.e. a minimum amount of crater defects at high line speed during extrusion coating.

It is another object of the present invention to provide a support for recording media at relatively low nip pressure with superior surface properties, i.e. a minimum amount of crater defects at high line speed during extrusion coating.

These and other objects of the present invention are achieved by providing a support for recording media wherein the outermost layer at the image bearing side of said support comprises a specific type of copolymer, in particular a α-olefin based polymer. The copolymer can be a copolymer of:

an α-olefin and an α,β-unsaturated carboxylic acid;

an α-olefin and an ester of an α,β-unsaturated acid;

an α-olefin and an anhydride of an α,β-unsaturated dicarboxylic acid;

an α-olefin and a vinyl-ester; or

combinations thereof.

Preferably the support is not
a corona treatment activated photographic base paper with a weight of 167 g/m², co-extrusion coated with three resin layers, an outermost resin layer comprising an ethylene methacrylic acid copolymer with a melt flow index of 4.0 dg/min measured at 190° C./2.16 kg according to ASTM D1238 and a density of 922 kg/m³, a middle layer containing a low density polyethylene with a melt flow index of 7.5 dg/min measured at 190° C./2.16 kg according to ASTM D1238 and a density of 919 kg/m³, 25% anatase titanium dioxide and ultramarine pigments and optical brightener and a lowermost layer adjacent to the base paper containing low density polyethylene with a melt flow index of 7.5 dg/min measured at 190° C./2.16 kg according to ASTM D1238 and a density of 919 kg/m³, 5% anatase titanium dioxide and further more ultramarine pigments; the total coating weight of the resin layers being 30 g/m²; the outermost layer applied with a coating weight of 1 g/m²; the resin layers being co-extruded with a line speed of 350 m/min, a melt temperature of 325° C. and linear pressure of 370 N/cm;
a corona treatment activated photographic base paper with a weight of 167 g/m², co-extrusion coated with three resin layers, an outermost resin layer comprising an ethylene methacrylic acid copolymer with a melt flow index of 7.0 dg/min measured at 190° C./2.16 kg according to ASTM D1238 and a density of 922 kg/m³, a middle layer containing a low density polyethylene with a melt flow index of 7.5 dg/min measured at 190° C./2.16 kg according to ASTM D1238 and a density of 919 kg/m³, 25% anatase titanium dioxide and ultramarine pigments and optical brightener and a lowermost layer adjacent to the base paper containing low density polyethylene with a melt flow index of 7.5 dg/min measured at 190° C./2.16 kg according to ASTM D1238 and a density of 919 kg/m³, 5% anatase titanium dioxide and further more ultramarine pigments; the total coating weight of the resin layers being 30 g/m²; the outermost layer applied with a coating weight of 1 g/m²; the resin layers being co-extruded with a line speed of 350 m/min, a melt temperature of 325° C. and linear pressure of 370 N/cm;
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 95:5, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm;
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 80:20, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm; or
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 50:50, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm.

The disclaimer may be introduced to delimit from the non-prepublished European patent application EP-A-1 650 599.

### DETAILED DESCRIPTION OF CERTAIN PREFERRED EMBODIMENTS

The present invention provides a support comprising a substrate having a topside and a backside, wherein at least the topside is provided with at least two non-oriented resin layers, wherein the outermost layer (viz. the layer that is most distant from the substrate), comprises a specific copolymer. The copolymer used for this purpose in accordance with the present invention can be a copolymer of an α-olefin and an α,β-unsaturated carboxylic acid, an α-olefin and an ester of an α,β-unsaturated acid, an α-olefin and an anhydride of an α,β-unsaturated di-carboxylic acid, an α-olefin and a vinyl ester. Herein, the topside is in particular the side that is intended to be provided with a receiving medium, such as a recording medium.

As used herein, the term “non-oriented resin” means that the resin has not been stretched in a direction after the extrusion coating process for instance in order to create microvoids when stretching is done in the presence of void-initiating materials in the resin.

With the present invention it has become possible to provide a support for a recording medium that can be produced at high line speeds, without unacceptable crater defects. Furthermore the support of the present invention can be produced at high speeds with a low thickness of polymer resin, expressed as weight of resin per surface area. The invention also provides a support for recording media which can be produced at relatively low resin melt temperature at high line speeds during melt extrusion coating with a low amount of crater defects. The invention provides furthermore a support for recording media that gives a high smoothness and gloss, while using readily available, easily processable, low cost polyolefin raw materials.

Surprisingly it was found that replacing the resin of the outermost layer of the support from low density polyethylene for another polymer in particular a copolymer of an α-olefin and an α,β-unsaturated carboxylic acid, an α-olefin and an ester of an α,β-unsaturated acid, an α-olefin and an anhydride of an α,β-unsaturated di-carboxylic acid or an α-olefin and an vinyl-ester, leads to a dramatic reduction in the occurrence of crater defects. It is this finding that forms the basis of the present invention.

The term “α-olefin” as used in the present invention is preferably a substance represented by the formula RCH═CH₂, where in R represents a hydrogen atom or a hydrocarbon group having 1 to 8 carbons. Examples include ethylene, propylene, butene-1, pentene-1, hexene-1, heptene-1, octene-1, styrene, 3-methyl-butene-1 and 4-methyl butene-1. Among these ethylene and propylene are most preferred. A suitable amount of α-olefin in the copolymer ranges from 60-99 wt. %, preferably 75-95 wt. % and most preferably 80-90 wt. %. Suitable amounts for the other monomer i.e. α,β-unsaturated carboxylic acid, ester of an α,β-unsaturated acid, anhydride of an α,β-unsaturated di-carboxylic acid, vinyl-ester, or combinations thereof range from 1-40 wt. %, preferably 5-25 and most preferably from 10-20 wt. %.

The α,β-unsaturated carboxylic acid preferably include acrylic acid, methacrylic acid, α-ethyl acrylic acid, itaconic acid, maleic acid, fumaric acid, or combinations thereof. Further the group of α,β-unsaturated carboxylic acid may include an amide- or a nitrile derivative of an α,β-unsaturated carboxylic acid. Among the group of α,β-unsaturated carboxylic acids the use of acrylic acid and methacrylic acid as monomers are preferred.

Among the group of anhydrides of α,β-unsaturated di-carboxylic acids maleic anhydride is preferred.

Examples of esters of α,β-unsaturated acid used in the invention include those having between 3 and 10 carbon atoms. Among these the use of methacrylate, propyl acrylate, butyl acrylate and/or glycidyl methyl acrylate as monomers are preferred.

Other monomers which may be selected according to the present invention include vinyl esters, vinyl amide, or vinyl acetate. Among these vinyl acetate is preferred.

It is not necessary that the resin of the outermost layer according to the present invention is composed as a copolymer of only two components as monomer. Apart from the use of an α-olefin monomer, any combination of monomers of the aforementioned α,β-unsaturated carboxylic acid, ester of an α,β-unsaturated acid, anhydride of an α,β-unsaturated di-carboxylic acid and vinyl-ester may be used. Suitable amounts for the α-olefin monomer ranges from 60-99 wt. %, more preferred 65-95 wt. % and more preferably from 70-90 wt. % in the total polymer. Apart for the α-olefin monomer the other monomer's suitable amounts range from 1-40% wt. %, preferably 5-35% and most preferably 10-30 wt. % in the total polymer. A preferred example according to this invention is the use of a terpolymer of ethylene, butyl acrylate and maleic anhydride.

In another preferred embodiment, mixtures of the afore mentioned copolymers are used. It is even more preferred to use a mixture of at least one afore mentioned copolymer and at least one other resin in the outermost resin layer. This other resin is preferably a polymer of an α-olefin with carbon atom amount between 2 and 8. Preferred are one or more low density polyethylenes or linear low density polyethylenes or polypropylene or polybutene-1.

The mixtures of the aforementioned polymers can be a dry blend mixture or a melt blend mixture. When utilizing mixtures of afore mentioned (co)polymers, if was found that the crater defect performance can be improved even further by the usage of more effective mixing screws in the extruder e.g. screws with chaotic mixing elements or elongational mixing elements, or by using compounds prepared in an off-line or on-line “piggy back” twin screw extruder or other mixing devices, e.g. Banbury mixer, Bush co-kneader, and the like.

It was found that with the increase of the polyethylene content of the mixture of polymers in the outermost resin layer of the support, the occurrence of crater defects again increases. Therefore, from a practical point of view in a trade-off between crater defects and other properties, such a mixture should preferably comprise not more than 30% on a weight basis of polyethylene on the total weight of the outermost layer.

The flow properties of the mixture of the (co)polymers in the outermost layer of the present layer is chosen in such a way that under the production conditions of the present invention there will be no or an acceptable level of interfacial instability between this outermost layer and the layer below this outermost layer and that there is no or an acceptable level of layer encapsulation.

In principle there is no limit to the coating weight of the outermost layer of the support of the present invention. When the support is used for instance as a support for a photographic printing paper, the presence of a non-pigmented outer layer leads to a reduction in sharpness of the image on the support, where the reduction in sharpness is increasing with an increase in the coating weight of the outermost layer of the support. Also for economical reason it is generally not preferred to use too high coating weights of (co)polymers. Therefore the coating weight of the outermost layer is preferably 3 g/m² or less, more preferably 1 g/m² or less. However from practical coating point of view the coating weight is present with a minimum of 0.2 g/m².

The outermost layer of the support of the present invention can be colored with one or more white opacifying pigments when required e.g. for improvement of image sharpness in the case that the support is used for instance as a support for a photographic printing paper or for improvement of the whiteness or opacity of the support. This white opacifying pigment may be selected from any of the white pigments described in the art, such as anatase type titanium dioxide, rutile titanium dioxide, zinc oxide, zinc sulphide, lithopone and the like, and mixtures of any of these. The type of white pigment in the outermost layer of the support of the present invention preferably comprises anatase type or rutile type titanium dioxide, or mixtures of these titanium dioxide types of pigments. Preferably the particle size of the anatase type or rutile type titanium dioxide is between 0.1 μm and 0.4 μm and the concentration of the white pigment in the outermost layer of the support does not exceed 20 weight % based on the total weight of the outermost layer. Higher amounts may give rise to die drool and these defects will lead to deterioration of the appearance of the support and require a production stop to remedy them. If present, the amount of white pigment is at least 5%.

The outermost layer of the support of the present invention may be provided with one or more substances, such as known additives for resin coated substrates. In particular the outermost layer may contain additional (small) quantities of one or more colored dyes or pigments and/or blueing agents, e.g. ultramarine blue and/or violet, cobalt blue, phosphoric oxide cobalt, quinacridone pigments and mixtures of these. One or more optical brighteners, most preferably bis-benzoxazole type optical brighteners, may be present. One or more antioxidants, e.g. hindered phenol type anti-oxidants, phosphite type anti-oxidants, lactone type anti-oxidants and mixtures of these, may be present. Further the outermost layer may comprise one or more additives selected from the group consisting of anti-static agents; UV-stabilizers and/or light stabilizers, e.g. hindered amine light stabilizers; nickel chelates; substituted benzophenones or benzotriazole; chill-roll release agents, e.g. metal stearates; fluoropolymers; polyalcohols; polyethylene glycol; polypropylene glycol; other substances used as known additives for resin coated substrates; and combinations thereof. Adhesion of the outermost resin layer to the recording layer (in order to provide the recording medium) can be improved by conventional surface treatment methods known in the art e.g. corona treatment, plasma treatment, flame treatment, heat treatment or chemical priming or combinations of surface treatment methods.

The second resin layer of a support of the present invention usually has a coating weight of between 5 g/m² and 50 g/m², and preferably between 9 g/m² and 25 g/m². The type of resin in the second resin layer of the invention can be chosen from any type of (extrusion coating) resin known in the art, preferably the resin in the second layer of the invention is a polyolefin or olefin copolymer or a mixture of olefinic polymers. In a preferred embodiment of the invention the type of resin used in the second layer is a polyethylene resin or a mixture of different polyethylene resins. In the most preferred embodiment of the invention the type of resin used in the second layer is a low density polyethylene resin or a mixture of different low density polyethylene resins.

The resins or resin mixtures in the various layers of the present invention can be chosen independently from each other depending on the intended properties of the end product. The values of the melt flow index of the resins or resin mixtures in the second layer of the present invention is chosen in such a way that under the production conditions of the present invention there will be no or an acceptable level of interfacial instability between this second layer and the layer(s) adjacent to this second layer and that there is no or an acceptable level of layer encapsulation.

The second layer of the present invention may further comprise one or more white opacifying pigment to enhance the whiteness and opacity of the support, or in the case this support is used as a support for a photographic paper to increase the sharpness of the image. This white opacifying pigment can be selected from any of the white pigments described in the art, like anatase type titanium dioxide, rutile titanium dioxide, zinc oxide, zinc sulphide, lithopone and the like, and mixtures thereof. In a particularly preferred embodiment of the invention, the type of white pigment in the second layer of the support of the present invention comprises anatase type or rutile type titanium dioxide, or a mixture of these pigments. Preferably, the particle size of the anatase type or rutile type titanium dioxide is between 0.1 μm and 0.4 μm and the concentration of the white pigment in the second layer of the support does not exceed 35 weight % based on the total weight of the second layer. The anatase type titanium dioxide is preferably used in order to obtain a very good whiteness. The pigment types in the outermost layer and in the second layer may be chosen independently from each other. For example, titanium dioxide of the anatase type may be used in one of the layers and titanium dioxide of the rutile type may be used in another layer.

Optionally, the second resin layer of the support of the present invention may contain additionally one or more pigments like nacreous pigments and/or (small quantities of) one or more colored dyes or pigments and/or blueing agents, e.g. ultramarine blue and/or violet, cobalt blue, phosphoric oxide cobalt, quinacridone pigments and mixtures of these. Further one or more additives from the group consisting of optical brighteners, most preferably bis-benzoxazole type optical brighteners, antioxidants, e.g. hindered phenol type anti-oxidants, phosphite type anti-oxidants, lactone type anti-oxidants and mixtures of these, anti-static agents e.g. semi-conductive metal oxide particles, UV-stabilizers and/or light stabilizers, e.g. hindered amine light stabilizers, nickel chelates, substitutes benzophenones or benzotriazole, and other substances used as known additives for resin coated recording media may be selected.

Additionally, the second resin layer of the support of the present invention may contain one or more adhesion promoting additives, e.g. as known in the art, in order to improve the adhesion of the second layer with the outermost resin layer, to improve the adhesion of the second resin layer towards a possible third resin coating layer, or, when the second resin layer is the lowermost resin layer which is in contact with the substrate, to improve the adhesion towards this substrate (see e.g. U.S. Pat. No. 5,466,519 for examples of suitable additives). If desired, the adhesion of the lowermost resin layer to the substrate can be improved by giving the lowermost resin layer an ozone-melt treatment.

Alternatively, there may be applied a tie layer as described in the art to promote adhesion between the second resin layer and the outermost resin layer, between the second resin layer and a possible third resin coating layer, or, when the second resin layer is the lowermost resin layer which is in contact with the substrate, to improve the adhesion of this second resin layer with this substrate. If desired, the adhesion of the resin to the substrate can be improved by giving the tie layer, for instance when the tie layer is the lowermost resin layer an ozone-melt treatment.

The melt temperature of the second resin layer of the present invention when utilized as the lowermost resin layer which is in contact with the substrate can be chosen at a sufficiently high level to promote the adhesion of this second layer to the substrate without the need of adhesion promoting additives and/or tie layers. For this in case the second resin layer is a polyethylene, the melt temperature is preferably at least 300° C. and more preferably at least 280° C.

The application of a third layer below the second layer of the present invention may be advantageous in order to prevent the generation of die lip stripes in the case that the second layer of the present invention comprises a high concentration of titanium dioxide or other pigments. The third layer of the present invention may have a coating weight between 1 g/m² and 50 g/m², and preferably between 2 g/m² and 25 g/m². In a preferred embodiment of the invention the type of resin used in the third layer is a polyolefin type or a olefin copolymer or a mixture of various olefinic polymer type resins. In a particularly preferred embodiment of the invention the type of resin used in the third layer is a low density polyethylene resin or a mixture of different low density polyethylene resins. The resins or resin mixtures of this third layer can be chosen independently from the resins of the other layers and may be different depending on the intended properties of the end product. The values of the melt flow index of the resins or resin mixtures in the third layer of the present invention are chosen in such a way that under the production conditions of the present invention there will be no or an acceptable level of interfacial instability between this third layer and the resin layer(s) adjacent to this third layer and in such a way that there is no or an acceptable level of layer encapsulation.

The third layer of the present invention further preferably comprises a white opacifying pigment or a mixture of white opacifying pigments, most preferably an anatase type or rutile type titanium dioxide or mixture of these pigments with a particle size between 0.1 μm and 0.4 μm. The concentration of the white pigment in the third layer preferably does not exceed 20 weight % based on the total weight of this third layer and most preferably does not exceed 15 weight %. The pigment types in the third layer and in the second layer may be chosen independently from each other. So, titanium dioxide of the anatase type may be used in one of the layers and titanium dioxide of the rutile type may be used in the another layer. Optionally, the third layer may comprise additional (small) quantities of one or more colored dyes or pigments and/or blueing agents, e.g. ultramarine blue and/or violet, cobalt blue, phosphoric oxide cobalt, quinacridone pigments and mixtures of these. In addition one or more additives may be selected from the group consisting of optical brighteners, most preferably bis-benzoxazole type optical brighteners, antioxidants, e.g. hindered phenol type anti-oxidants, phosphite type anti-oxidants, lactone type anti-oxidants and mixtures of these, anti-static agents e.g. semi-conductive metal oxide particles, UV-stabilizers and/or light stabilizers, e.g. hindered amine light stabilizers, nickel chelates, substituted benzophenones or benzotriazole and other substances used as known additives for resin coated recording media. Additionally, the third resin layer of the support of the present invention may comprise adhesion promoting additives as known in the art in order to improve the adhesion of the third layer with the second adjacent resin layer, to improve the adhesion of the third resin layer towards the substrate or when the lower-most resin is a tie layer to improve the adhesion from the third resin-layer to this tie layer. Examples of these adhesion promoting additives are, but not limited to those alone, disclosed in U.S. Pat. No. 6,466,519.

In order to promote the adhesion between the third layer and the adjacent second layer and/or the substrate, the usage of a tie layer as described in the art above and/or below a third layer and/or the usage of an adhesion promoting additive in the third layer is possible.

Alternatively (or if desired, in addition), the melt temperature of a third resin layer of the present invention, when utilized as the lowermost resin layer which is in contact with the substrate, can be chosen at a sufficiently high level to promote the adhesion of this third layer to the substrate without the need of expensive adhesion promoting additives and/or tie layers. For this in case the third resin layer is a polyethylene, the melt temperature should be at least 300° C. and more preferably at least 280° C.

If desired, the adhesion of the resin to the substrate can be improved by giving the lowermost resin layer an ozone melt treatment.

The support of the present invention, comprising a substrate having a topside and a backside, can also be provided on its backside with at least one resin layer and/or at least one other coating layer depending on the properties to be achieved like for instance waterproofing, anti-static, anti-curling, anti-blocking, anti-slip, splice strength, and/or the ability to receive and retain prints (e.g. bar codes or other indicia containing useful information). In the case the intended use of the support of the present invention is as the base for a photographic printing paper or a base for an inkjet paper, this backside is preferably extrusion coated with polyethylene resin(s) and most preferably a mixture of low density polyethylene and high density polyethylene. On top of this polymer layer an anti-static coating, an anti-sticking coating and so on may be provided.

The substrate of the support of the present invention can be chosen from any substrate known in the art like a raw paper base comprising high quality natural pulp such as a photographic paper base, a pigment coated paper base, a synthetic paper base or a polymer sheet base. The preferred substrate in the present invention is a raw paper base containing high quality natural pulp or a pigment coated paper base with a weight of 80-350 g/m², and most preferably with a substrate weight of 120 to 250 g/m². When using a pigment coated paper base as the substrate of the recording medium of the present invention, the average surface roughness (Ra) of the side of the pigment coated paper which receives the resin layers in accordance with the present invention, can be higher than those of the prior art, for instance those specified in EP-A-1 126 081, while still obtaining a surface without pits or crater defects. Thus, the use of high pigment coating layer weights and/or the use of multiple coating layers and/or supercalendering in the manufacturing of the pigment coated paper substrate can be avoided, which greatly reduces the manufacturing costs of said pigment coated paper base. The prior art teaches that an average surface roughness Ra below 1 μm is needed for a paper base as substrate in order to prevent the occurrence of crater like defects upon applying a polymer resin layer. In the present invention when using a pigment coated paper base as substrate, the average surface roughness of the side of the pigment coated paper which receives the at least two non-oriented resin layers can be more than 1. Preferably, the roughness is less than 2.0 μm and more preferred less than 1.5 μm and most preferred below 1.0 μm.

When using in the present invention as substrate a raw paper base, the average surface roughness of the substrate can also be more than 1, but is preferably less than 1.5 and more preferred less than 1.0 μm.

In case a pigment coated paper base is used as substrate in the present invention then the total dry coating weight of the pigment coating which is applied as an aqueous dispersion of binder and pigments on the paper base is preferably present in less than 60 g/m² and most preferably in less than 30 g/m². Even lower total coating weights of the pigment coating are possible with the present invention because of the superior ability to reduce the number of crater defects. The whiteness of the pigment coated substrate can be adjusted by addition of white pigments and/or blue dye and/or optical brighteners in the pigmented coating. Its gloss can be adjusted to the required level by calendering and/or super calendering and by selection of the appropriate pigment type(s) and particle size and size distribution. Typical pigments which can be used in the pigment coated paper substrate for the present invention are calcium carbonate, kaolin, barium sulphate, titanium oxide, clay, magnesium-aluminum silicate, aluminum oxide hydroxide, styrene-acrylic copolymers and combinations thereof. The particle size of the pigments is not particularly limited, but a more narrow particle size distribution can have benefits in providing adhesion or gloss. Pigments in which at least 70% of the particles have a size smaller than 1 μm and at least 40% have a size between 0.35 and 0.8 μm may be advantageously used.

Typical binders which can be used in the pigment coated paper base for the present invention include styrene acrylate latex, styrene-butadiene latex, methyl methacrylate-butadiene latex, polyacrylate latex, polyvinyl alcohol, starch and other polysaccharide, and combinations thereof. When using as the substrate of the recording medium of the present invention a pigment coated paper the resin layer adjacent to the pigment coating of the paper preferably contains pigments or fillers e.g. titanium oxide, talcum, calcium carbonate in order to (additionally) increase the adhesion of this resin layer with the pigment coating of the paper.

When using the recording medium comprising a support of the present invention, which has as substrate a pigment coated paper base as a photographic printing paper an additional advantage offered by the pigment coated paper is that the amount of the titanium oxide in the resin layers of the present invention can be decreased because of pigment coating effectively hides the natural paper part of the pigment coated paper. Thus, the manufacturing costs can be decreased additionally without loosing image sharpness compared to traditional photographic printing papers known in the art.

Depending on the use of the support, the layer structure of the present invention can be applied on the topside only or on the topside and also the backside of the substrate.

If necessary, the front surface, and optionally also the back surface of the substrate of the support of the present invention is subjected to an activation treatment before the melt-extrusion process. The treatment may comprise a corona treatment and/or a flame treatment and/or ozone treatment and/or plasma treatment and/or plasma deposition treatment and/or a heat treatment and/or chemical priming.

The support of the present invention can be manufactured by (tandem) extrusion coating techniques or consecutive extrusion coating techniques as described in the art. Most preferably the support of the present invention is manufactured by a co-extrusion technique in which all resin layers of the present invention and if required tie layers are applied to the substrate at the same time using feed block techniques or multi manifold die techniques and combinations of these techniques. This greatly increases the economy of the manufacturing of the support. In the (co)extrusion line, the molten resin which is extruded from the die can furthermore be treated by ozone in order to improve the adhesion between the resin and the substrate. In order to even further improve the adhesion between the resin and the substrate, the melt temperature of the resin layer which is extruded from the die is at least 280° C.

The preferred speeds for the co-extrusion process for the manufacturing of the support of the present invention may be up to 200 or 300 or 450 or even more than 600 m/min which even more increases the economy of the manufacturing of the support. It is also possible to reduce the total amount of extrusion coated resin, while keeping the same amount of pits. It is for example possible to reduce the amount of topside coated resins from 30 g/m² to 20 g/m² by changing over from an outermost layer of polyethylene to an outermost layer comprising a copolymer of the present invention keeping the same amount of pits.

The nip pressure of the manufacturing of the support of the present invention, where the nip is in between a chill roll and a pressure roll with a pressure function, is preferably below 1500 N/cm, more preferably below 700 N/cm. The surface structure of the chill roll used in the manufacturing of the support of the present invention can be any glossy structure, including a mirror glossy type surface because of the many advantages of the present invention, however, most preferred is a glossy fine matte surface. In (co)extrusion coating, the amount of crater defects can even be further reduced when the present invention is combined with a higher temperature of the cooling medium in the chill roller. In one embodiment of this invention the cooling medium temperature is higher than 12° C. but not exceeding 50° C.

The invention further relates to a recording medium, comprising a support as described herein and preferably a receiving medium. The receiving medium is usually provided at the side of the outermost resin layer that is remote from the substrate. The receiving medium may be a photographically active layer, such as an emulsion layer for photography, an ink receiving layer (such as from inkjet applications) a recording layer for thermal paper application or a recording layer for electro-photographical paper application. The recording medium may be manufactured in a manner known in the art.

The copolymers of the present invention can be obtained commercially, or can be produced by standard polymerization techniques. The copolymers can be random, block or grafted copolymers.

The invention further relates to the use of the above-mentioned copolymer which comprises an α-olefin, i.e. a copolymer comprising an α-olefin and an α,β-unsaturated carboxylic acid, an α-olefin and an ester of an α,β-unsaturated acid, an α-olefin and an anhydride of an α,β-unsaturated di-carboxylic acid and/or an α-olefin and a vinyl ester or the use of a copolymer of an α-olefin and any combination of α,β-unsaturated carboxylic acids, esters of α,62 -unsaturated acids, anhydrides of α,β-unsaturated di-carboxylic acids and vinyl esters as monomer to reduce crater defect formation in a support material for a recording medium.

Preferably said support is not
a corona treatment activated photographic base paper with a weight of 167 g/m², co-extrusion coated with three resin layers, an outermost resin layer comprising an ethylene methacrylic acid copolymer with a melt flow index of 4.0 dg/min measured at 190° C./2.16 kg according to ASTM D1238 and a density of 922 kg/m³, a middle layer containing a low density polyethylene with a melt flow index of 7.5 dg/min measured at 190° C./2.16 kg according to ASTM D1238 and a density of 919 kg/m³, 25% anatase titanium dioxide and ultramarine pigments and optical brightener and a lowermost layer adjacent to the base paper containing low density polyethylene with a melt flow index of 7.5 dg/min measured at 190° C./2.16 kg according to ASTM D1238 and a density of 919 kg/m³, 5% anatase titanium dioxide and further more ultramarine pigments; the total coating weight of the resin layers being 30 g/m²; the outermost layer applied with a coating weight of 1 g/m²; the resin layers being co-extruded with a line speed of 350 m/min, a melt temperature of 325° C. and linear pressure of 370 N/cm;
a corona treatment activated photographic base paper with a weight of 167 g/m², co-extrusion coated with three resin layers, an outermost resin layer comprising an ethylene methacrylic acid copolymer with a melt flow index of 7.0 dg/min measured at 190° C./2.16 kg according to ASTM D1238 and a density of 922 kg/m³, a middle layer containing a low density polyethylene with a melt flow index of 7.5 dg/min measured at 190° C./2.16 kg according to ASTM D1238 and a density of 919 kg/m³, 25% anatase titanium dioxide and ultramarine pigments and optical brightener and a lowermost layer adjacent to the base paper containing low density polyethylene with a melt flow index of 7.5 dg/min measured at 190° C./2.16 kg according to ASTM D1238 and a density of 919 kg/m³, 5% anatase titanium dioxide and further more ultramarine pigments; the total coating weight of the resin layers being 30 g/m²; the outermost layer applied with a coating weight of 1 g/m²; the resin layers being co-extruded with a line speed of 350 m/min, a melt temperature of 325° C. and linear pressure of 370 N/cm;
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 95:5, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm;
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 80:20, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm; or
a corona treatment activated photographic base paper with a weight of 167 g/m², co-extrusion coated with three resin layers, an outermost resin layer containing high melt strength polypropylene and polypropylene maleic acid copolymer, having a melt flow index of 3.7 dg/min measured at 190° C./2.16 kg according to ASTM D1238 and a density of 915 kg/m³, in a ratio of 50:50, a middle layer containing low density polyethylene with a melt flow index of 15 dg/min measured at 190° C./2.16 kg according to ASTM D1238 and a density of 918 kg/m³, 25% anatase titanium dioxide and further more ultramarine pigments and optical brightener, and a lowermost layer adjacent to the base paper containing low density polyethylene with a melt flow index of 15 dg/min measured at 190° C./2.16 kg according to ASTM D1238 and a density of 918 kg/m³, 5% anatase titanium dioxide and further more ultramarine pigments; the total coating weight of the resin layers being 30 g/m², the outermost layer being applied with a coating weight of 1 g/m²; the resin layers being co-extrusion coated with a line speed of 300 m/min, a melt temperature of 325° C. and linear pressure of 320 N/cm.

The present invention will be elucidated below in further detail with reference to the examples, but the present invention is not limited thereto. Unless otherwise indicated, all parts, percents, ratios and the like are by weight.

### EXAMPLES

All experiments were run on a co-extrusion line equipped with two 4½″ (11.43 cm) and one 2½″ (6.35 cm) extruders, feed-block and coat-hanger die. The substrates used in the experiments were photographic paper bases (PP) and pigment coated paper (PCP) bases. The substrates were corona treated prior to extrusion coating by in-line corona treatment stations. All experiments were performed using glossy fine matte chill rollers.

The ultramarine pigments used in the examples are a mixture of ultramarine violet and ultramarine blue. The optical brightener used in the examples is a bis-benzoxazole substituted stilbene type optical brightener. Pigments and optical brighteners were applied from master batches with low density polyethylene as carrier resin.

The following abbreviations are used for the different resins which were investigated: low density polyethylene: LDPE; linear low density polyethylene: LLDPE; ethylene acrylic acid: EAA; ethylene vinyl acetate: EVA; ethylene methyl acrylate: EMA; ethylene ethyl acrylate: EEA; ethylene butyl acrylate: EBA; ethylene butylacrylate maleic anhydride terpolymer: EBAMAH; ethylene glycidyl methacrylate: EGMA; polypropylene: PP; acrylic acid: AA; vinyl acetate: VA; methyl acrylate: MA; ethyl acrylate: EA; butyl acrylate: BA; maleic anhydride: MA; and glycidyl methacrylate: GMA.

Table 1 summarizes the resins which were used in the production of the various examples.

TABLE 1

| | | Melt Flow | |
|---|---|---|---|
| | | index | Density |
| Resin | | (dg/min) | (kg/m³) |
| LDPE | | 22 | 919 |
| LLDPE | | 6.6 | 910 |
| EAA | 11 wt. % AA | 12 | 939 |
| EVA | 18 wt. % VA | 14 | 938 |
| EMA | 26 wt. % MA | 6.0 | 922 |
| EEA | 11 wt. % EA | 6.0 | 925 |
| EBA | 16 wt. % BA | 6.5 | 920 |
| EBAMAH | 18 wt. % BA/3 wt. % MAH | 5 | 940 |
| EGMA | 8 wt. % GMA | 5 | 940 |
| PP | | 22 | 905 |

The melt flow indexes of the resins EAA, EVA, EMA, EEA, EBA, EBAMAH, EGMA were measured at 190° C./2.16 kg; the melt flow index of PP was measured at 230° C./2.16 kg (measured according to ASTM D1238).

In the examples the amount and size of the crater defects were measured by microscopy combined with image analysis software provided by Zeiss. The software divides the crater defects in four size classes: <300 μm², 300-800 μm², 800-1300 μm² and >1300 μm², respectively. The latter two classes are the most important for the visual judgment of the quality of the substrate. Therefore, a weighed average which gives preferential treatment to the larger size classes is used for the analysis of the crater defect data. In order to compare these measurements the results are rated from 1 to 10, with 1 being the worst with respect to crater defects and 10 being the best with respect to crater defects. In the examples, the rating of 5 is the internal reference.

### Example Series

Corona treatment activated photographic base paper (weight 163 g/m²) and pigment coated paper (weight 172 g/m²) were co-extrusion coated at the topside with three resin layers, an 1 g/m² outermost resin layer or skin layer with a variable composition, 12.5 g/m² of a middle layer containing LDPE, 25% anatase titanium dioxide and further more ultramarine pigments and optical brightener, and a variable weight (6.5 or 11.5 or 16.5 g/m²) of a lowermost layer adjacent to the base paper containing LDPE, 5% anatase titanium dioxide and further more ultramarine pigments. The resin layers were co-extrusion coated with a line speed of 420 and 500 m/min, a melt temperature of 325° C. and a nip pressure of 700 N/cm.

The average roughness (R_{α}) of the photographic base (PP) paper was 1.4 μm and that of the pigment coated base (PCP) paper was 0.9 μm.

Roughness (R_{α}) method: according to ISO 4287-1997

cut-off wave-length (λc): 0.8 mm

sample measuring length: 5.6 mm

apparatus/type: Mahr Perthometer/M3

The effect of composition of skin-layer and of substrate and the total resin-content on top of the substrate and of line speed on the rating of crater defects for co-extrusion coated samples were determined and compared in Table 2.

TABLE 2

| | | Line speed | Total resin | Skin-layer | Rating (PP as | Rating (PCP |
|---|---|---|---|---|---|---|
| | | (m/min) | content (g/m²) | composition | substrate) | as substrate) |
| Test 1 | C | 420 | 30 | LLDPE/LDPE*) | a5 | 7 |
| Test 2 | C | 500 | 30 | LLDPE/LDPE*) | 4 | 6 |
| Test 3 | C | 500 | 25 | LLDPE/LDPE*) | 3 | 5 |
| Test 4 | C | 500 | 20 | LLDPE/LDPE*) | 1 | 3 |
| Test 5 | I | 420 | 30 | EAA | 9 | 10 |
| Test 6 | I | 500 | 30 | EAA | 7 | 9 |
| Test 7 | I | 500 | 25 | EAA | 6 | 7 |
| Test 8 | I | 500 | 20 | EAA | 4 | 6 |
| Test 9 | I | 420 | 30 | EVA | 7 | 10 |
| Test 10 | I | 500 | 30 | EVA | 6 | 9 |
| Test 11 | I | 500 | 25 | EVA | 5 | 7 |
| Test 12 | I | 500 | 20 | EVA | 3 | 5 |
| Test 13 | I | 420 | 30 | EMA | 8 | 10 |
| Test 14 | I | 500 | 30 | EMA | 7 | 9 |
| Test 15 | I | 500 | 25 | EMA | 6 | 8 |
| Test 16 | I | 500 | 20 | EMA | 3 | 5 |
| Test 17 | I | 420 | 30 | EEA | 9 | 10 |
| Test 18 | 1 | 500 | 30 | EEA | 8 | 9 |
| Test 19 | I | 500 | 25 | EEA | 6 | 8 |
| Test 20 | I | 500 | 20 | EAA | 4 | 6 |
| Test 21 | I | 420 | 30 | EBA | 8 | 10 |
| Test 22 | I | 500 | 30 | EBA | 6 | 7 |
| Test 23 | I | 500 | 25 | EBA | 5 | 6 |
| Test 24 | I | 500 | 20 | EBA | 3 | 4 |
| Test 25 | I | 420 | 30 | EBAMAH | 8 | 10 |
| Test 26 | I | 500 | 30 | EBAMAH | 6 | 9 |
| Test 27 | I | 500 | 25 | EBAMAH | 5 | 7 |
| Test 28 | I | 500 | 20 | EBAMAH | 3 | 5 |
| Test 29 | I | 420 | 30 | EGMA | 9 | 10 |
| Test 30 | I | 500 | 30 | EGMA | 7 | 8 |
| Test 31 | I | 500 | 25 | EGMA | 6 | 7 |
| Test 32 | I | 500 | 20 | EGMA | 4 | 5 |
| Test 33 | I | 420 | 30 | EAA/PP*) | 10 | 10 |
| Test 34 | I | 500 | 30 | EAA/PP*) | 9 | 10 |
| Test 35 | I | 500 | 25 | EAA/PP*) | 8 | 9 |
| Test 36 | I | 500 | 20 | EAA/PP*) | 6 | 8 |
| Test 37 | I | 420 | 30 | EVA/PP*) | 9 | 10 |
| Test 38 | I | 500 | 30 | EVA/PP*) | 8 | 10 |
| Test 39 | I | 500 | 25 | EVA/PP*) | 7 | 8 |
| Test 40 | I | 500 | 20 | EVA/PP*) | 5 | 7 |
| Test 41 | I | 420 | 30 | EMA/PP*) | 9 | 10 |
| Test 42 | I | 500 | 30 | EMA/PP*) | 7 | 10 |
| Test 43 | I | 500 | 25 | EMA/PP*) | 6 | 8 |
| Test 44 | I | 500 | 20 | EMA/PP*) | 5 | 6 |
| Test 45 | I | 420 | 30 | EEA/PP*) | 9 | 10 |
| Test 46 | I | 500 | 30 | EEA/PP*) | 8 | 9 |
| Test 47 | I | 500 | 25 | EEA/PP*) | 7 | 8 |
| Test 48 | I | 500 | 20 | EEA/PP*) | 5 | 7 |
| Test 49 | I | 420 | 30 | EBA/PP*) | 8 | 10 |
| Test 50 | I | 500 | 30 | EBA/PP*) | 7 | 9 |
| Test 51 | I | 500 | 25 | EBA/PP*) | 6 | 8 |
| Test 52 | I | 500 | 20 | EBA/PP*) | 5 | 7 |
| Test 53 | I | 420 | 30 | EBAMAH/PP*) | 9 | 10 |
| Test 54 | I | 500 | 30 | EBAMAH/PP*) | 7 | 10 |
| Test 55 | I | 500 | 25 | EBAMAH/PP*) | 6 | 8 |
| Test 56 | I | 500 | 20 | EBAMAH/PP*) | 5 | 7 |
| Test 57 | I | 420 | 30 | EGMA/PP*) | 9 | 10 |
| Test 58 | I | 500 | 30 | EGMA/PP*) | 8 | 9 |
| Test 59 | I | 500 | 25 | EGMA/PP*) | 7 | 8 |
| Test 60 | I | 500 | 20 | EGMA/PP*) | 5 | 6 |
| Test 61 | I | 420 | 30 | EAA/PP/LDPE**) | 7 | 8 |
| Test 62 | I | 500 | 30 | EAA/PP/LDPE**) | 6 | 7 |
| Test 63 | I | 500 | 25 | EAA/PP/LDPE**) | 5 | 6 |
| Test 64 | I | 500 | 20 | EAA/PP/LDPE**) | 3 | 5 |

*)1/1 (wt/wt) mixture
**)0.35/0.35/0.3 (wt/wt/wt) mixture
C = Comparative sample;
I = Inventive sample

It is clear from Table 2 that the crater defects rating has been improved tremendously in the inventive samples. Further it is clear that total resin-weight reduction and line speed increase negatively influence the effect on crater defect ratings. However it is clear that by using the inventive skin-layer compositions and by using of a pigment coated paper as substrate that there is room to reduce the total resin-weight on top of the substrate and/or increase the line speed and still get an acceptable crater defect rating compared to the comparative ones.

1. A support for a recording medium comprising a substrate, which substrate is provided on at least one side with at least two non-oriented resin layers, wherein the resin layer furthest away from said substrate (layer A) comprises at least one copolymer of an α-olefin monomer and at least one second monomer selected from the group consisting of:
an α,β-unsaturated carboxylic acid;
an ester of an α,β-unsaturated acid;
an anhydride of an α,β-unsaturated di-carboxylic acid; and
combinations thereof.

2. The support according to claim 1, in which said copolymer comprises 60-99 wt. % α-olefin and 1-40 wt. % of said second monomer.

3. The support according to claim 1, in which said α-olefin monomer is selected from the group consisting of ethylene, propylene, and combinations thereof.

4. The support according to claim 1, wherein said second monomer is selected from an α,β-unsaturated carboxylic acid, an ester of α,β-unsaturated carboxylic acid, an anhydride of α,β-unsaturated dicarboxylic acid, and combinations thereof.

5. The support according to claim 1, wherein said layer A further comprises at least one other resin, preferably a resin comprising an α-olefin polymer, which forms a mixture with said copolymer.

6. The support according to the claim 5, in which said α-olefin polymer of said at least one other resin is selected from the group consisting of polyethylene, polypropylene, and combinations thereof.

7. The support according to claim 5, in which said layer A comprises at most 30 wt. % of said at least one other resin, based on the total weight of said layer A.

8. The support according to claim 1, wherein said layer A is present in an amount of 3 g/m² or less.

9. The support according to claim 1, wherein said layer A further comprises one or more opacifying pigments or colored pigments.

10. The support according to claim 1, wherein said other non-oriented resin layer (layer B), which is between said layer A and said substrate comprises polyethylene resin, optionally in the form of a mixture of different polyethylene resins.

11. The support according to claim 10, wherein said layer B is present in an amount of 5 g/m²-50 g/m².

12. The support according to claim 10, wherein said layer B further comprises one or more opacifying pigments or colored pigments.

13. The support according to claim 1, wherein at least a third resin layer (layer C) is provided in between the layer B and the substrate and which comprises polyethylene resin or mixtures of polyethylene resins.

14. The support according to claim 13, wherein said layer C is present in an amount of 1 g/m²-50 g/m².

15. The support according to claim 13, wherein said layer C further comprises one or more opacifying pigments or colored pigments.

16. The support according to claim 1, wherein said substrate comprises a raw paper base, a pigment coated paper base, a synthetic paper base or a polymer sheet base.

17. The support according to claim 1, wherein said substrate is a pigment coated paper base having an average surface roughness on the side of said at least two non-oriented resin layers of less than 2.0 μm.

18. The support according to claim 1, wherein said substrate is a paper base having an average surface roughness on the side of said at least two non-oriented resin layers of less than 1.5 μm.

19. A process for manufacturing a support according to claim 1, comprising:
a co-extrusion coating step, wherein said at least two resin layers are extruded simultaneously via a feedblock, a multimanifold die, or a combination thereof at elevated temperature on a moving substrate;
a combination step having a certain line speed, wherein said resin layers and said substrate are combined in a nip, having a nip pressure, which nip is in between a chill roll having a chilling function and a pressure roll having a pressure function; and
a removal step, wherein the support is removed from the chill roll while the support is at a lower temperature than that of the polymer resin melt.

20. The process according to the previous claim 19, wherein said support is manufactured with a line speed of at least 200 m/min.

21. The process according to claim 19 wherein said support is manufactured with a melt temperature of at least 280° C.

22. The process according to claim 19, wherein the nip pressure is below 1500 N/cm.

23. A recording medium comprising a support according to claim 1.

24. The recording medium according to claim 23, further comprising a receiving medium.

25. Use of a copolymer of an α-olefin monomer and at least one second monomer selected from the group consisting of: α,β-unsaturated carboxylic acid; an ester of an α,β-unsaturated acid; an anhydride of an α,β-unsaturated di-carboxylic acid; a vinyl-ester; and combinations thereof in an outermost resin layer of a support which support comprises at least two non-oriented resin layers for the reduction of crater defect formation in a support material for a recording medium.

26. The support according to claim 1, in which said copolymer comprises 75-95 wt. % α-olefin and 5-25 wt. % of said second monomer.

27. The support according to claim 1, in which said copolymer comprises 80-90 wt. % α-olefin and 10-20 wt. % of said second monomer.
